(19) United States
(12) Patent Application Publication
(10) Pub. No.: US 2025/0242516 A1
(43) Pub. Date: Jul. 31, 2025

(54) GARDEN TOOL

(71) Applicant: ZHEJIANG SUNSEEKER INDUSTRIAL CO., LTD., Jinhua (CN)

(72) Inventor: Lingmin SHAO, Jinhua (CN)

(73) Assignee: ZHEJIANG SUNSEEKER INDUSTRIAL CO., LTD., Jinhua, ZJ (CN)

(21) Appl. No.: 18/855,699

(22) PCT Filed: Feb. 7, 2023
(86) PCT No.: PCT/CN2023/074798

§ 371 Date: Oct. 11, 2024

(30) Foreign Application Priority Data
Apr. 15, 2022 (CN) 202210414912.8
Apr. 15, 2022 (CN) 202220886604.0

(51) Int. Cl. B27B 17/08

(52) U.S. Cl. CPC B27B 17/083

(57) ABSTRACT

A garden tool, comprising a machine body (1), wherein a power portion (2) on a prime mover is arranged in the machine body (1), and a mechanical brake assembly (3) for braking the power portion is arranged in the machine body (1); the mechanical brake assembly (3) comprises a brake control member and a position limiting member, wherein the brake control member comprises a handle (31) and a first mechanical brake sheet (32), and the handle (31) is linked with the first mechanical brake sheet (32); a first position of the brake control member is formed when the first mechanical brake sheet (32) is away from the power portion (2), and a second position of the brake control member is formed when the first mechanical brake sheet (32) is in pressing contact with the power portion (2); and the position limiting member comprises an elastic member (4), and is configured to keep the brake control member in the first position or the second position. According to the garden tool, the brake control member is in pressing contact with the power portion (2), such that the power portion (2) is decelerated or stopped, and a braking state or a non-braking state is maintained through the elastic member (4). The garden tool is simple in structure and high in reliability.

### RELATED APPLICATIONS CROSS-REFERENCE

This present application claims priority based on the following two Chinese patent applications:
Filing date: Apr. 15, 2022; Application number: 2022104149128; Invention name: A garden tool;
Filing date: Apr. 15, 2021; Application number: 2022208866040; Invention name: A garden tool;

The full text of the above applications is incorporated into this document by reference.

### TECHNICAL FIELD

This disclosure relates to the technical field of electric tools, in particular to a garden tool.

### BACKGROUND

Chainsaw is a very commonly used garden tool, which typically utilize a braking device to slow down or stop the motor during operation. In the garden tools commonly found on the market, electronic and mechanical brakes are often used in conjunction to achieve the braking of the garden tool; electronic brakes are only suitable for garden tools with low-speed rotation, while mechanical brakes can be applied to garden tools with high-speed rotation. However, the mechanical brake part uses a V-shaped spring element to provide elasticity. The metal spring element is in contact with the plastic casing, and the part of the casing that contacts the spring element can wear out after long-term use. This can result in insufficient handle elasticity, which may easily lead to safety hazards. The reliability of the mechanical brakes in the comparative documents is also poor, and the practical use of electronic brakes has certain limitations. Therefore, there is a need to design a reliable garden tool.

### SUMMARY

To the existing problems in the prior art, this invention designs a garden tool. The invention involves using a brake control member to press contact with the power portion, thereby allowing the power portion to slow down or shut down, and maintaining the braking or non-braking state through an elastic member, resulting in a simple structure and high reliability.

The inventive purpose of this invention is achieved through the following technical solution: a garden tool that includes a machine body, a power portion on a prime mover is arranged in the machine body. The machine body also includes a mechanical brake assembly for braking the power portion, the mechanical brake assembly includes a brake control member and a position limiting member. The brake control member includes a handle and a first mechanical brake sheet, with the handle and the first mechanical brake sheet being linked together. When the first mechanical brake sheet is away from the power portion, a first position of the brake control member is formed; when the first mechanical brake sheet is in pressing contact with the power portion, a second position of the brake control member is formed. The position limiting member includes an elastic member and is constructed to maintain the brake control member in the first position or the second position.

Preferably, the machine body is provided with a limiting section located on the side away from the power portion relative to the brake control member and the mechanical brake assembly abuts on the limiting section when the brake control member is in the first position.

The brake control member abuts on the limiting section, so as to be prevented from further rotation and maintained in the first position under the action of the position limiting member.

Preferably, the power portion on the prime mover is an external rotor of an external rotor motor.

Preferably, further including an electronic braking system and a control switch; the control switch is constructed to be triggered by the brake control member; the electronic braking system is constructed to apply electronic braking to the prime mover when the control switch is triggered.

The control switch is triggered by the brake control member, simultaneously starting the electronic braking system, which can also decelerate the external rotor through the electronic braking system.

Preferably, the machine body has a first connecting shaft, and the brake control member is pivoted to the machine body through the first connecting shaft, with the handle and the first mechanical brake sheet located on both sides of the first connecting shaft respectively; the first end of the elastic member is connected to the machine body through a first connection structure, and the second end of the elastic member is connected to the brake control member through a second connection structure; when the brake control member moves between the first position and the second position, the distance between the first connection structure and the second connection structure changes.

The first connecting shaft is set on the inside of the machine body, with the handle extending towards the outside of the machine body and the first mechanical brake sheet extending towards the inside of the machine body. The brake control member is pivoted to the machine body, so that when the handle is turned, the first mechanical brake sheet will be near to or away from the external rotor; the first end of the elastic member is connected to the machine body, and the second end of the elastic member is connected to the brake control member, and the length of the elastic member will change during the switching process between the first position and the second position of the brake control member.

Preferably, during the process where the brake control member moves from the first position towards the second position, the second connection structure moves closer to the power portion.

Preferably, the second connection structure is constructed to be located between the first connecting shaft and the first connection structure; when the brake control member is in a third position, the first connecting shaft, the first connection structure, and the second connection structure are collinear; and when the brake control member is in the third position, the elastic member is not in a stretched state.

The brake control member will pass through the third position in the process of moving from the first position to the second position. At this time, the first connecting shaft, the first connection structure and the second connection structure are collinear, and the elastic member is always in a compressed state, being compressed to have the shortest length at the third position. The length of the elastic member at the first position or at the second position is less than the length at the third position. When the brake control member is in the third position, the length of the elastic member does not exceed its original length and remains in a compressed state.

Preferably, the first connecting shaft is constructed to be located between the first connection structure and the second connection structure; when the brake control member is in the third position, the first connecting shaft, the first connection structure, and the second connection structure are collinear; and when the brake control member is in the third position, the elastic member is not in a compressed state.

As the brake control member moves from the first position towards the second position, it will pass through the third position. At this time, the first connection structure and the second connection structure are collinear, and the elastic member is always in a stretched state, being stretched to be the largest at the third position. The length of the elastic member at the first position or second position is shorter than that at the third position. When the brake control member is in the third position, the length of the elastic member is not less than its original length and remains in a stretched state.

Preferably, the first end of the elastic member is pivoted to the machine body through the first connection structure; the second end of the elastic member is pivoted to the brake control member through the second connection structure.

Preferably, the elastic member is constructed as a tension spring; the first connection structure includes a first shaft and a shaft sleeve; the first shaft is constructed to be fixedly connected to the machine body; the shaft sleeve is constructed to be rotatably mounted on the first shaft; the first end of the elastic member is relatively fixedly connected to the shaft sleeve; the second connection structure includes a first pin shaft, the first connecting shaft is set between the first pin shaft and the first shaft, and the second end of the elastic member is pivoted to the first pin shaft.

When the elastic member is in a non-compressed state, the first end of the elastic member is set as a hook portion, so that the first end is always hooked on the shaft sleeve via the hook portion. As the elastic member rotates with the brake control member, the first end of the elastic member will never leave the shaft sleeve, thus the first end of the elastic member is in a relatively fixed connection state with the shaft sleeve. The second end of the elastic member is also set as a hook portion, which hooks on the first pin shaft, so that the elastic member is always in a stretched state.

Preferably, the shaft sleeve is constructed to be made of a metal material. The shaft sleeve is preferably made of aluminum or steel.

Preferably, the elastic member is constructed as a spiral spring; the position limiting member also includes a spring seat, which is constructed to include a receiving chamber, the length of which is not less than the largest length of the elastic member; one end of the spring seat is hinged to the brake control member through the second pin shaft; the second end of the elastic member is relatively fixedly connected to the spring seat.

The width of the receiving chamber is slightly greater than the diameter of the elastic member to prevent excessive radial deformation of the elastic member during movement. The receiving chamber is used to accommodate the elastic member, with the second end of the elastic member abutting on the inner wall of the receiving chamber and the first end of the elastic member resting against the surface of the shaft sleeve. The largest length of the elastic member refers to the greater one of the lengths of the elastic member when the brake control member is in the first position and when it is in the second position. Therefore, the elastic member will always be in a compressed state when being placed inside the spring seat.

Preferably, the first connection structure includes a first shaft and a shaft sleeve; the first shaft is constructed to be fixedly connected to the machine body; the shaft sleeve is constructed to be rotatably mounted on the first shaft; the first end of the elastic member is relatively fixedly connected to the shaft sleeve; the shape of the end of the receiving chamber that is away from the second pin shaft is adapted to match the shaft sleeve.

The elastic member is installed inside the spring seat, with the first end of the elastic member abutting on the surface of the shaft sleeve, and the second end of the elastic member abutting on the position of the receiving chamber that is away from the installed shaft sleeve. The spring seat is hinged to the brake control member through the second pin shaft, so that when the elastic member is in a compressed state, the spring seat will press contact with the brake control member. The first end of the elastic member is always in close contact with the surface of the shaft sleeve. The end of the receiving chamber that is away from the second pin shaft is set as an arc that adapts to the outer contour of the shaft sleeve, and the inner diameter of this arc is slightly larger than the outer diameter of the shaft sleeve, the same as the width of the receiving chamber.

Preferably, the mechanical brake assembly also includes a second mechanical brake sheet; the second mechanical brake sheet is constructed to be set on the brake control member or the position limiting member.

The first mechanical brake sheet is fixedly connected to the mounting seat, and the second mechanical brake sheet is fixedly connected to the spring seat. The first mechanical brake sheet and second mechanical brake sheet are arranged alternately up and down. The two mechanical brake sheets simultaneously decelerate the external rotor, which provides a better deceleration effect.

Compared with the prior art, the beneficial effects of this invention will be described in the section of the detailed description of embodiments.

### BRIEF DESCRIPTION OF THE DRAWINGS

FIG. 1 is a stereogram of the present invention;

FIG. 2 is a schematic diagram showing the first mechanical brake sheet of the present invention in the first position;

FIG. 3 is a schematic diagram showing the first mechanical brake sheet of the present invention in the second position;

FIG. 4 is an exploded view of the present invention;

FIG. 5 is an exploded view of the present invention using a tension spring;

FIG. 6 is a use status diagram of the present invention using a tension spring;

FIG. 7 is a schematic diagram showing the mechanical brake assembly of the present invention with dual brake sheets in the first position;

FIG. 8 is a schematic diagram showing the mechanical brake assembly of the present invention with dual brake sheets in the second position.

FIG. 9 is a use status diagram of the present invention;

FIG. 10 is a stereogram of the spring seat.

### DETAILED DESCRIPTION OF EMBODIMENTS

Further description of the present invention is provided below with reference to the embodiment shown in the drawings:

### Embodiment 1

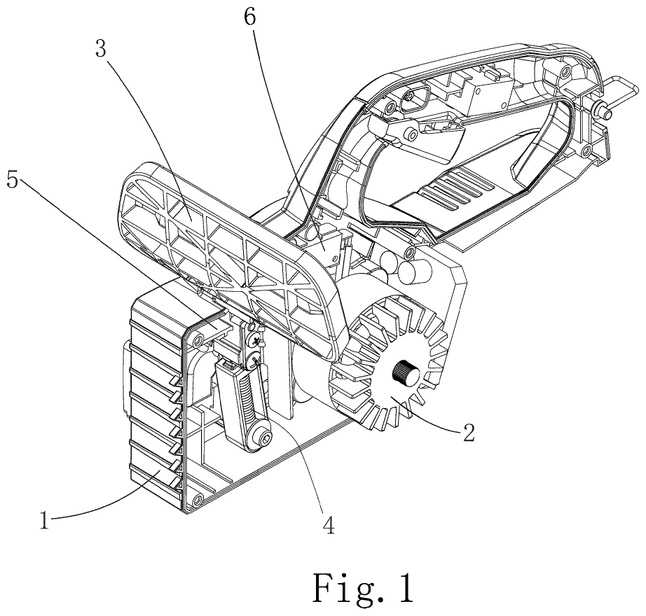

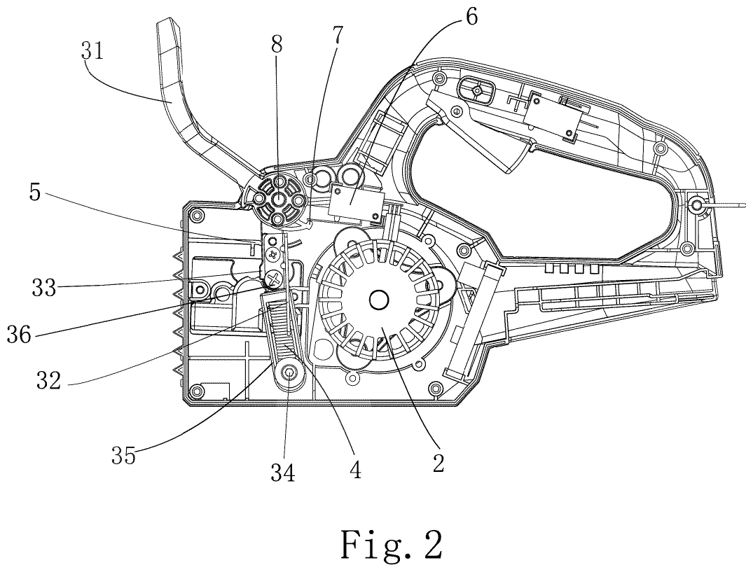

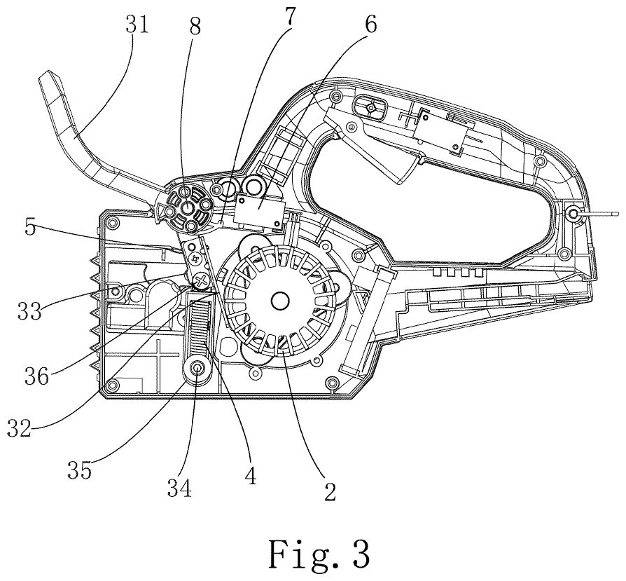

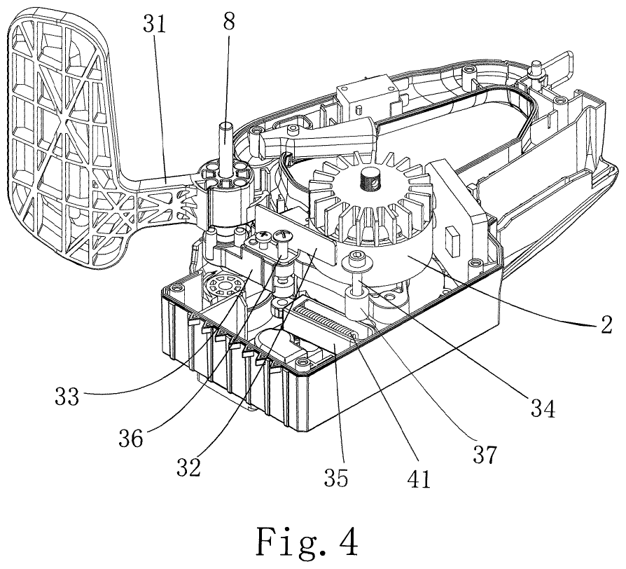

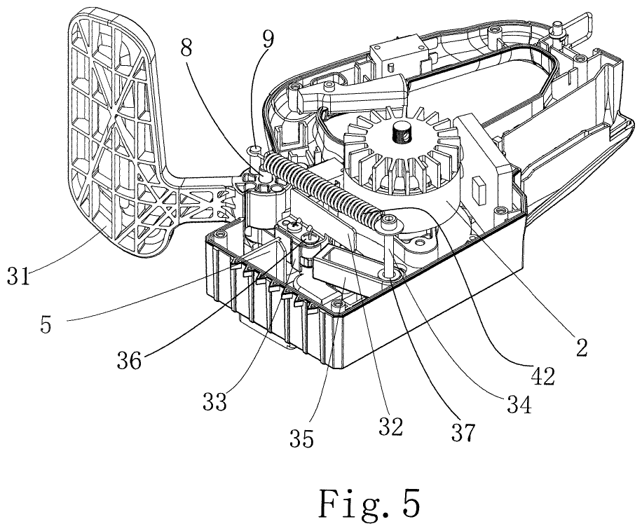

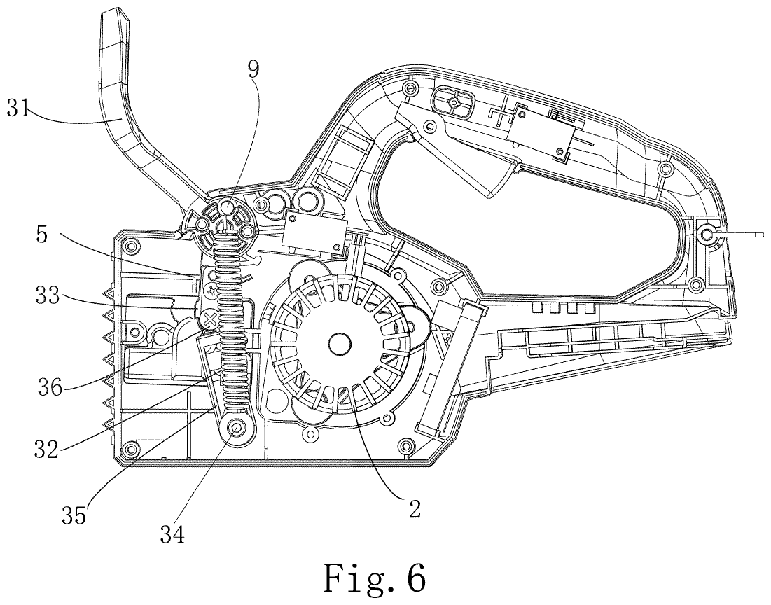

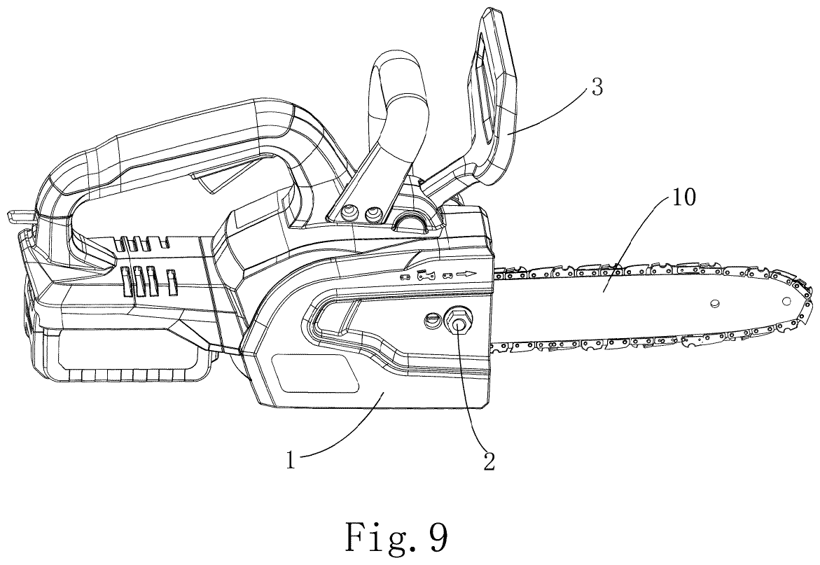

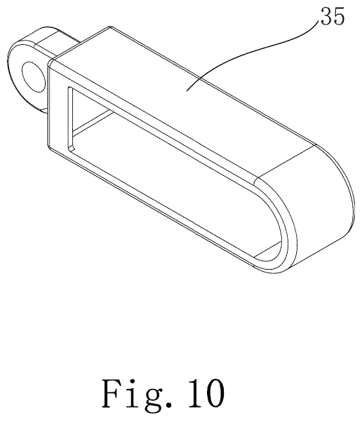

As shown in FIGS. 1 to 10, this embodiment 1 discloses a garden tool, including a machine body 1. A power portion 2 on a prime mover is arranged in the machine body 1. The machine body 1 also includes a mechanical brake assembly 3 for braking the power portion 2. The mechanical brake assembly 3 includes a brake control member and a position limiting member. The brake control member includes a handle 31 and a first mechanical brake sheet 32, which are linked together. When the first mechanical brake sheet 32 is away from the power portion 2, a first position of the brake control member is formed. When the first mechanical brake sheet 32 is in pressing contact with the power portion 2, a second position of the brake control member is formed. The position limiting member includes an elastic member 4. The position limiting member is constructed to maintain the brake control member in the first position or the second position.

The machine body 1 has a limiting section 5 relative to the side of the brake control member and away from the power portion 2. When the brake control member is in the first position, the mechanical brake assembly 3 abuts on the limiting section 5. The brake control member, when abutting on the limiting section 5, cannot continue to rotate and will be maintained in the first position under the action of the position limiting member. The power portion 2 on the prime mover is an external rotor of an external rotor motor. In this embodiment, the prime mover is constructed as an electric motor, with the power portion 2 being the external rotor of the external rotor motor. In some embodiments, the prime mover is constructed as an internal combustion engine, with the power portion 2 being constructed as a passive disk connected to the output shaft. The machine body 1 also has an electronic braking system and a control switch 6. The control switch 6 is constructed to be able to be activatable by the brake control member. The electronic braking system is constructed to apply electronic braking to the prime mover when the control switch 6 is triggered. The control switch 6 is triggered by the brake control member, simultaneously starting the electronic braking system, which can also decelerate the external rotor through the electronic braking system.

The machine body 1 is equipped with a first connecting shaft 8, through which the brake control member is pivoted to the machine body 1. The handle 31 and the first mechanical brake sheet 32 are located on both sides of the first connecting shaft 8 respectively. The first end of the elastic member 4 is connected to the machine body 1 through a first connection structure, and the second end of the elastic member 4 is connected to the brake control member through a second connection structure. When the brake control member moves between the first position and the second position, the distance between the first connection structure and the second connection structure changes. The first connecting shaft 8 is set on the inside the machine body 1, with the handle 31 extending towards the outside of the machine body and the first mechanical brake sheet 32 extending towards the inside of the machine body. The brake control member is pivoted to the machine body 1, so when the handle 31 is turned, the first mechanical brake sheet 32 will be near to or away from the external rotor. The first end of the elastic member 4 is connected to the machine body 1, and the second end of the elastic member 4 is connected to the brake control member. The length of the elastic member 4 changes as the brake control member switches between the first and second positions. As the brake control member moves from the first position towards the second position, the second connection structure moves closer to the power portion 2. The second connection structure is constructed to be located between the first connecting shaft 8 and the first connection structure. When the brake control member is in the third position, the first connecting shaft 8, the first connection structure, and the second connection structure are collinear, and the elastic member 4 is not in a stretched state. The brake control member will pass through the third position in the process of moving from the first position to the second position. At this time, the first connecting shaft 8, the first connection structure, and the second connection structure are collinear, and the elastic member 4 is always in a compressed state, being compressed to the shortest at the third position. The length of the elastic member 4 at the first position or at the second position is greater than the length at the third position. When the brake control member is in the third position, the length of the elastic member 4 does not exceed its original length and remains in a compressed state.

The first end of the elastic member 4 is pivoted to the machine body 1 through the first connection structure; the second end of the elastic member 4 is pivoted to the brake control member through the second connection structure. The elastic member 4 is constructed as a spiral spring; the position limiting member also includes a spring seat 35, which is constructed to include a receiving chamber. The length of the receiving chamber is not less than the largest length of the elastic member 4; one end of the spring seat 35 is hinged to the brake control member through a second pin shaft 36; the second end of the elastic member 4 is relatively fixedly connected to the spring seat 35. The width of the receiving chamber is slightly greater than the diameter of the elastic member 4 to prevent excessive radial deformation of the elastic member 4 during movement. The receiving chamber is used to accommodate the elastic member 4, with the second end of the elastic member 4 abutting on the inner wall of the receiving chamber and the first end of the elastic member 4 resting against the surface of the shaft sleeve 37; the largest length of the elastic member 4 refers to the greater one of the lengths of the elastic member 4 when the brake control member is in the first position and when it is in the second position. Therefore, the elastic member 4 will always be in a compressed state when being placed inside the spring seat 35. The first connection structure includes a first shaft 34 and a shaft sleeve 37; the first shaft 34 is constructed to be fixedly connected to the machine body 1; the shaft sleeve 37 is constructed to be rotatably mounted on the first shaft 34; the first end of the elastic member 4 is relatively fixedly connected to the shaft sleeve 37; the end of the receiving chamber that is away from the second pin shaft 36 is shaped to match the shaft sleeve 37. The elastic member 4 is installed inside the spring seat 35, with the first end of the elastic member 4 resting against the surface of the shaft sleeve 37, and the second end of the elastic member 4 abutting on the position of the receiving chamber that is away from the installed shaft sleeve 37. The spring seat 35 is hinged to the brake control member through the second pin shaft 36, so that when the elastic member 4 is in a compressed state, the spring seat 35 will press contact with the brake control member. The first end of the elastic member 4 is always in close contact with the surface of the shaft sleeve 37. The end of the receiving chamber that is away from the second pin shaft 36 is set as an arc that adapts to the outer contour of the shaft sleeve 37, and the inner diameter of this arc is slightly larger than the outer diameter of the shaft sleeve 37, the same as the width of the receiving chamber.

The specific working process of this embodiment is as follows: during the use of the garden tool, the power portion 2 is in a high-speed rotation state, at this time, the first mechanical brake sheet 32 is in the first position, and the mechanical brake assembly 3 is in a non-braking state. The handle 31 is pulled, and the handle 31 and the mounting seat 33 rotate counterclockwise synchronously around the first connecting shaft 8; the handle 31, while rotating, contacts the protrusion 7 to touch the control switch 6, and the control switch 6 breaks the circuit. When the circuit is broken, the power portion 2 will continue to rotate due to inertia; as the handle 31 rotates, the first mechanical brake sheet 32 will rotate from the third position to the second position. When the first mechanical brake sheet 32 is in the second position, it will press contact with the power portion 2 to achieve deceleration or stoppage of the power portion 2.

The working principle that the first mechanical brake sheet 32 is maintained in the first position or second position is as follows: the distance between the first connecting shaft 8 and the second pin shaft 36 always remains constant and is L1, the distance between the second pin shaft 36 and the first shaft 34 will change and is L2, and the distance between the first connecting shaft 8 and the first shaft 34 remains constant and is L3. When the first mechanical brake sheet 32 is in the third position, the mounting seat 33 and the spring seat 35 are aligned on the same straight line, L3=L1+L2, at this time, the compression spring 41 inside the spring seat 35 is compressed to the shortest position, and the elasticity is the largest. When the handle 31 is pulled, and the mounting seat 33 presses contact with the limiting section 5, the mounting seat 33 cannot rotate further, so the first mechanical brake sheet 32 will remain in the first position. When the first mechanical brake sheet 32 on the mounting seat 33 is in pressing contact with the power portion 2, the first mechanical brake sheet 32 cannot continue to rotate and remains in the second position, so that the mechanical brake assembly 3 is in the braking state. When the first mechanical brake sheet 32 is in the first position or second position, the mounting seat 33 and the spring seat 35 are not on the same straight line; at this time, L3<L1+L2, the position of the second pin shaft 36 will be away from the first shaft 34, and L2 will become longer. The mounting seat 33 is hinged to the spring seat 35, and as the mounting seat 33 rotates, it will be away from the first shaft 34, which also causes the spring seat 35 to move along with it. As the spring seat 35 moves, the compression spring 41 inside it will elongate and its elastic deformation will decrease. Since the elastic deformation of the compression spring 41 is the largest when the first mechanical brake sheet 32 is in the third position, if the first mechanical brake sheet 32 needs to move from the first position or second position to the third position, it must overcome the elastic force of the compression spring 41 to allow the handle 31 to drive the mounting seat 33 to rotate. Therefore, without the action of an external force, the compression spring 41 inside the spring seat 35 will press against the spring seat 35, and the spring seat 35 will press against the mounting seat 33, keeping the first mechanical brake sheet 32 on the mounting seat 33 always remained in the first position or second position.

The power portion 2 is connected to the saw chain 10 and drives it to rotate. When the mechanical brake assembly 3 is pressed and the first mechanical brake sheet 32 is in the second position, the saw chain 10 stops rotating. When the mechanical brake assembly 3 is pulled and the first mechanical brake sheet 32 is in the first position, the saw chain 10 can rotate normally.

### Embodiment 2

As shown in FIGS. 1 to 6, this embodiment discloses a method of using a tension spring 42 to maintain the first mechanical brake sheet 32 in the first position or second position. The other structures are the same as those in Embodiment 1, except for the structure and installation method of the elastic member 4. The elastic member 4 is constructed as a tension spring 42. The first connection structure includes a first shaft 34 and a shaft sleeve 37. The first shaft 34 is constructed to be fixedly connected to the machine body 1. The shaft sleeve 37 is constructed to be rotatably mounted on the first shaft 34. The first end of the elastic member 4 is relatively fixedly connected to the shaft sleeve 37. The second connection structure includes a first pin shaft 9, the first connecting shaft 8 is set between the first pin shaft 9 and the first shaft 34, and the second end of the elastic member 4 is pivoted to the first pin shaft 9. When the elastic member 4 is in an uncompressed state, the first end of the elastic member 4 is set as a hook portion, so that the first end is always hooked on the shaft sleeve 37. As the elastic member 4 rotates with the brake control member, the first end of the elastic member 4 will never leave the shaft sleeve 37, thus the first end of the elastic member 4 is in a relatively fixed connection state with the shaft sleeve 37. The second end of the elastic member 4 is also set as a hook portion and hooks on the first pin shaft 9, so that the elastic member 4 is always in a stretched state. The shaft sleeve 37 is constructed to be made of a metal material. The shaft sleeve 37 is preferably made of aluminum or steel.

The working principle that the first mechanical brake sheet 32 is maintained in the first or second position is as follows: The distance between the first pin shaft 9 and the first shaft 34, denoted as S1, changes with the rotation of the handle 31. When the first mechanical brake sheet 32 is in the third position, the mounting seat 33 and the tension spring 42 are aligned in a straight line. At this time, the first connecting shaft 8 is located between the first pin shaft 9 and the first shaft 34, and the distance between the first pin shaft 9 and the first shaft 34 is the largest, that is, S1 is the largest, and thus the extension of the tension spring 42 is the largest. When the mounting seat 33 rotates to a position where it is no longer in a straight line with the tension spring 42, the mounting seat 33 will be closer to the power portion 2 or the limiting section 5 on the machine casing. Simultaneously, the position of the first pin shaft 9 will be closer to the first shaft 34, causing S1 to decrease, and ultimately decreasing the extension of the tension spring 42. When the first mechanical brake sheet 32 switches from the first position or second position to the third position, it is necessary to apply an external force to lengthen the tension spring 42, overcoming the elastic force of the tension spring 42 by the external force, allowing for relative rotation between the mounting seat 33 and the tension spring 42. Therefore, without the external force, the first mechanical brake sheet 32 will always remain in the corresponding first position or second position.

### Embodiment 3

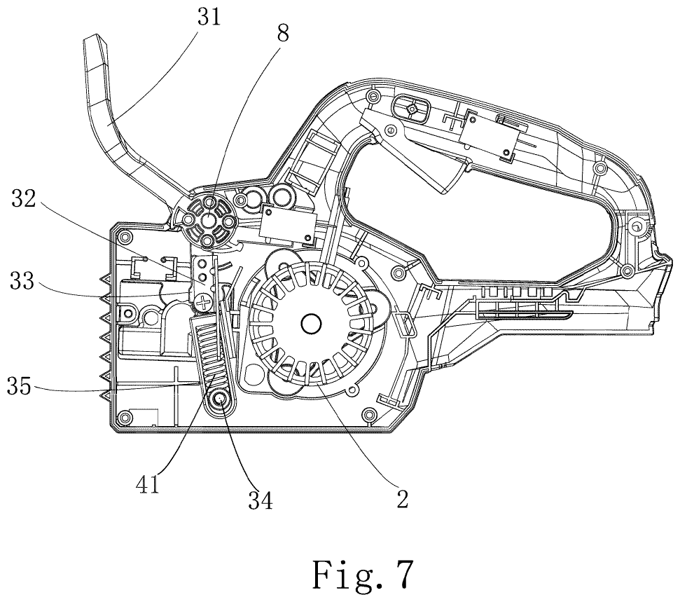

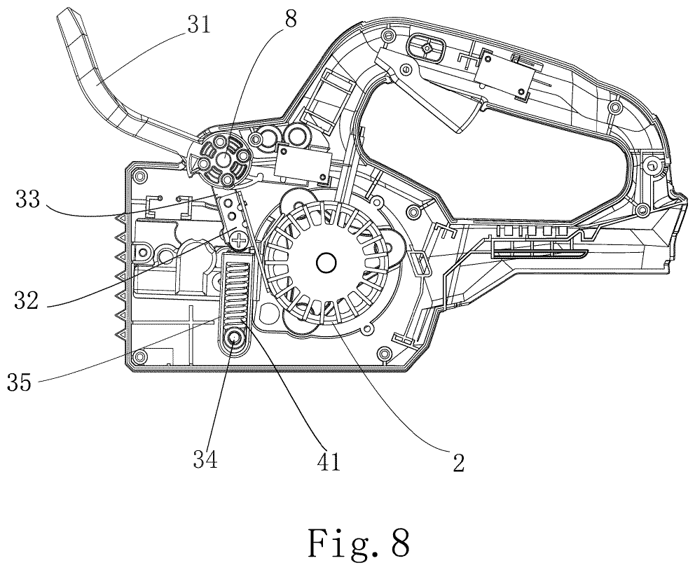

As shown in FIGS. 7 and 8, the first mechanical brake sheet 32 is set on the mounting seat 33 in this embodiment, and the second mechanical brake sheet is set on the spring seat 35; the other structures are the same as those in Embodiment 1. The mounting seat 33 is fixedly connected to the first mechanical brake sheet 32, and the second mechanical brake sheet is set on the spring seat 35. The first mechanical brake sheet 32 and the second mechanical brake sheet are set to be staggered up and down along the axial direction where the first connecting shaft 8 is located.

The specific working process of this embodiment is as follows: when the handle 31 is pulled, the handle 31 rotates and simultaneously drives the mounting seat 33 to rotate. The mounting seat 33 is hinged to the spring seat 35, and as the mounting seat 33 rotates, it drives the spring seat 35 to rotate. During the rotation of the mounting seat 33, the first mechanical brake sheet 32, which is fixedly connected to the mounting seat 33, approaches the power portion 2. During the rotation of the spring seat 35, the second mechanical brake sheet, which is fixedly connected to the spring seat 35, approaches the power portion 2. In this way, the first mechanical brake sheet 32 and the second mechanical brake sheet will simultaneously press contact with the power portion 2, increasing the contact area between the power portion 2 and the brake control member, thereby improving the braking effect of the brake control member.

In this invention, the brake control member drives the first mechanical brake sheet to be closer to or away from the power portion. When the first mechanical brake sheet is away from the power portion, it is in the first position of the brake control member; when the first mechanical brake sheet is in pressing contact with the power portion, it is in the second position of the brake control member, at this time, the motor rotor will slow down or stop. The brake control member includes a handle and the first mechanical brake sheet; the handle controls the rotation of the first mechanical brake sheet, which is a simple process and highly reliable and can stably achieve deceleration of the power portion. The mechanical brake assembly also includes a position limiting member, which includes an elastic member. The position limiting member has a stable structure and produces a good force even after long-term operation. When the brake control member is not subjected to external forces, the elastic member ensures that the first mechanical brake sheet is always maintained in the corresponding first position or second position, which is reliable and stable. Therefore, this invention simplifies the structure and improves the reliability of the garden tool to achieve the deceleration or stopping of the power portion on garden tools.

The specific embodiments described in the text are merely exemplary to illustrate the spirit of this invention. Technical personnel in the technical field of this invention can make various modifications, supplements, or replacements in a similar manner to the specific embodiments described, but they will not deviate from the spirit of this invention or exceed the scope defined by the appended claims.

1. A garden tool comprising a machine body, wherein a power portion on a prime mover is arranged in the machine body, and a mechanical brake assembly for braking the power portion is arranged in the machine body; the mechanical brake assembly comprises a brake control member and a position limiting member; the brake control member includes a handle and a first mechanical brake sheet, the handle and the first mechanical brake sheet are linked together; when the first mechanical brake sheet is away from the power portion, a first position of the brake control member is formed, and when the first mechanical brake sheet is in pressing contact with the power portion, a second position of the brake control member is formed; the position limiting member includes an elastic member, which is constructed to maintain the brake control member in the first position or the second position.

2. The garden tool according to claim 1, wherein the machine body is provided with a limiting section on the side away from the power portion relative to the brake control member; when the brake control member is in the first position, the mechanical brake assembly abuts on the limiting section.

3. The garden tool according to claim 1, wherein the power portion on the prime mover is an external rotor of an external rotor motor.

4. The garden tool according to claim 1, wherein the garden tool further comprises an electronic braking system and a control switch; the control switch is constructed to be triggered by the brake control member; the electronic braking system is constructed to apply electronic braking to the prime mover upon triggering of the control switch.

5. The garden tool according to claim 1, wherein the machine body has a first connecting shaft, and the brake control member is connected to the machine body through the first connecting shaft, and the handle and the first mechanical brake sheet is located on both sides of the first connecting shaft respectively; the first end of the elastic member is connected to the machine body through a first connection structure, and the second end of the elastic member is connected to the brake control member through a second connection structure;
wherein a distance between the first connection structure and the second connection structure changes when the brake control member moves between the first position and the second position.

6. The garden tool according to claim 5, wherein the second connection structure gets closer to the power portion during the movement of the brake control member from the first position to the second position.

7. The garden tool according to claim 5, wherein the second connection structure is constructed to be positioned between the first connecting shaft and the first connection structure;
the first connecting shaft, the first connection structure, and the second connection structure are collinear when the brake control member is in a third position; and the elastic member is not in a stretched state when the brake control member is in the third position.

8. The garden tool according to claim 5, wherein the first connecting shaft is constructed to be located between the first connection structure and the second connection structure;
the first connecting shaft, the first connection structure, and the second connection structure are collinear when the brake control member is in the third position; and the elastic member is not in a compressed state when the brake control member is in the third position.

9. The garden tool according to claim 7, wherein a first end of the elastic member is pivoted to the machine body through the first connection structure, and a second end of the elastic member is pivoted to the brake control member through the second connection structure.

10. The garden tool according to claim 9, wherein the first connection structure includes a first shaft and a shaft sleeve; the first shaft is constructed to be fixedly connected to the machine body; the shaft sleeve is constructed to be rotatably mounted on the first shaft; the first end of the elastic member is relatively fixedly connected to the shaft sleeve.

11. The garden tool according to claim 10, wherein the shaft sleeve is constructed to be made of a metal material.

12. The garden tool according to claim 9, wherein the elastic member is constructed as a spiral spring;
the position limiting member further includes a spring seat, and the spring seat is constructed to include a receiving chamber, and the length of the receiving chamber is not less than the largest length of the elastic member;
one end of the spring seat is hinged to the brake control member through a second pin shaft; and a second end of the elastic member is relatively fixedly connected to the spring seat.

13. The garden tool according to claim 12, wherein the first connection structure includes a first shaft and a shaft sleeve; the first shaft is constructed to be fixedly connected to the machine body; the shaft sleeve is constructed to be rotatably mounted on the first shaft; the first end of the elastic member is relatively fixedly connected to the shaft sleeve; and
the shape of the end of the receiving chamber that is away from the second pin shaft is adapted to match the shaft sleeve.

14. The garden tool according to claim 1, wherein the mechanical brake assembly further includes a second mechanical brake sheet; the second mechanical brake sheet is constructed to be provided on the brake control member or the position limiting member.
